(19) United States
(12) Patent Application Publication
(10) Pub. No.: US 2004/0107875 A1
(43) Pub. Date: Jun. 10, 2004

(54) Low-density cementing slurry

(76) Inventors: Bruno Drochon, Noisy le Grand (FR); Andre Garnier, Houston, TX (US)

Correspondence Address: SCHLUMBERGER TECHNOLOGY CORPORATION, IP DEPT., WELL STIMULATION, 110 SCHLUMBERGER DRIVE, MD1, SUGAR LAND, TX, 77478, US

(21) Appl. No.: 10/654,639

(22) Filed: Sep. 3, 2003

Related U.S. Application Data
(63) Continuation-in-part of application No. 10/049,198, filed on Jul. 2, 2002, now Pat. No. 6,626,991.

(30) Foreign Application Priority Data
Jul. 6, 2000 (WO) PCT/EP00/06459
Jul. 29, 1999 (FR) 99/09847

(51) Int. Cl. C04B 7/14

(52) U.S. Cl. 106/714; 106/716; 106/724; 106/737

(57) ABSTRACT

A well cementing slurry, includes a solid fraction and a liquid fraction and has a density of less than about 1500 kg/m³. The solid fraction includes a mixture of solid particulate materials including cement, having 60% to 90% by volume of the solid fraction of a first component with particles having a mean size lying in the range 20 microns to 400 microns and a density of less than 2000 kg/m³; and 10% to 30% by volume of the solid fraction of a second component having a mean particle diameter of less than 5 microns.

This application is a continuation in part of U.S. Ser. No. 10/049,198 filed Jul. 2^{nd}, 2002, the contents of which are incorporated herein by reference.

The present invention relates to cementing compositions and techniques for such as are used in oil wells, gas wells, water wells, geothermal wells, and the like. More precisely, the invention relates to the use of cementing slurries of low density and, in particular, low porosity.

After a well (such as an oil well) has been drilled, a casing or liner is lowered into the borehole and is cemented over all or part of its length. Cementing serves in particular to eliminate any fluid interchange between the various formation layers though which the borehole passes, preventing gas from rising via the annulus surrounding the casing, or indeed it serves to limit ingress of water into a well in production. Another objective of cementing is to consolidate and support the borehole and to protect the casing.

While it is being prepared and pumped into the well so as to be placed in the zone that is to be cemented, the cementing slurry must present relatively low viscosity (so as to be pumpable) and it must have rheological and other physical properties that are substantially stable. However, once it is in place, it is desirable for the cement to rapidly develop high compressive strength so as to enable other work to be performed on the well, and in particular so as to enable drilling to be continued.

The density of the cement slurry must be controlled such that the hydrostatic pressure of the column of cement (when placed in the well) at any point in the well at least balances the pore fluid pressure in the exposed geological formations through which the well passes in order to avoid any risk of fluid influx which can lead to loss of control of the well, and ultimately to blow out. This defines the lower limit of the density of the slurry. There is also an upper limit to the density, which is the hydrostatic pressure generated by the column of cement (plus the head losses due to the circulation of the fluids being pumped) must remain below the fracturing pressure of the exposed rocks in the section being cemented. Certain geological formations are very fragile and require slurries of densities close to that of water (8 pounds per gallon (ppg); 1000 kg/m³) or even lower to avoid exceeding this limit.

The risk of fluid influx diminishes with cement column height so the density required for compensating pore pressure is usually lower for a very long cement column. Cementing a large height of column in a single operation is desirable since it makes it possible to reduce the number of sections that are cemented. Each cementing operation results in a reduction in well diameter. Therefore, after a section has been cemented, drilling must be restarted at a smaller diameter, so having a large number of cemented sections requires the hole to be drilled near the surface that is of very large diameter if the reduction in diameter caused by multiple cementing operations is not to reduce the well diameter unduly at target depth. thereby giving rise to excess cost due to the large volume of rock to be drilled and due to the large weight of steel required for the sections of casing, given their large diameters.

All of those factors favor the use of cement slurries of very low density.

The cement slurries in the most widespread use have densities of about 1900 kg/m³, which is about twice the density desired for certain deposits. To lighten them, the simplest technique is to increase the quantity of water while adding stabilizing additives (known as “extenders”) to the slurry for the purpose of avoiding particles settling and/or free water forming at the surface of the slurry.

Manifestly, this technique cannot be used to provide a density close to 1000 kg/m³ Furthermore, hardened cements formed from such slurries have greatly reduced compressive strength, a high degree of permeability, and poor adhesive ability. For these reasons, the technique cannot be used effectively to achieve densities below about 1300 kg/m³ while still conserving good isolation between geological layers and providing sufficient reinforcement for the casing.

Another technique consists in lightening the cement slurry by injecting gas into it (generally air or nitrogen) before it sets in order to form a foam. The quantity of air or nitrogen added is such as to the foamed slurry reaches required density. This technique provides performance that is a little better than the technique of providing extended slurries with high water content described above since the density of gas is lower than that of water, so less needs to be added. Nevertheless, in oil industry applications density remains limited in practice to densities greater than 1100 kg/m³, even when starting with slurries that have already been lightened with water. Above a certain “quality of foam”, i.e. a certain ratio of gas volume to volume of the foamed slurry, the stability of the foam falls off very quickly, the compressive strength of the foam after it has set becomes too low, and its permeability becomes too high, thereby compromising durability in a hot aqueous medium which includes ions that are aggressive to a greater or lesser extent for cement.

An object of the present invention is to provide cementing slurries that are more particularly adapted to cementing oil wells or the like, having both low density and low porosity yet providing good physical properties, particularly compressive strength.

A well cementing slurry according to the invention comprises a solid fraction and a liquid fraction and has a density of less than about 1.5 g/cm³, wherein the solid fraction comprises a mixture of solid particulate materials including cement, the mixture comprising: 60% to 90%, preferably 70% to 85%, by volume of the solid fraction of a first component comprising particles having a mean size lying in the range 20 microns to 400 microns and a density of less than 2000 kg/ m³; and 10% to 30%, preferably 15% to 30%, by volume of the solid fraction of a second component having a mean particle diameter of less than 5 microns.

Preferably, the slurry has a density lying in the range 900 kg/m³ to 1300 kg/m³, in particular in the range 900 kg/m³ to 1100 kg/m³, and has porosity (volume ratio of liquid fraction over total slurry volume) of less than 55%, preferably lying in the range 38% to 50%, and more preferably less than 45%.

The first component can comprise 0 to 20% (by volume) of Portland cement, having particles with a mean diameter lying in the range 20 μm to 50 μm; and 0 to 30% (by volume) of gypsum.

The second component typically has a mean particle diameter lying in the range 0.5 μm to 5 μm, and can comprise silica, cement such as Portland cement, and slag, either individually or in mixtures thereof.

The low porosities that can be achieved make it possible to optimize mechanical properties and permeability. By presenting mechanical properties that are much better than those of conventional lightened systems, and permeabilities that are lower, the leakproofing and adhesion properties of ultralightweight cement and the resistance of such formulations to chemical attack are thus much better than with the systems presently in use for low densities, even though the invention makes it possible to reach densities that are exceptionally low, and in particular that are lower than the density of water. In addition, slurries of the invention do not require gas, thus making it possible to avoid the logistics that would otherwise be required for manufacturing foamed cements.

The method of the invention is characterized in that particulate components are either blended together in a dry state and incorporated into the slurry, or added separately to the slurry, such that in combination with one another, in particular the fine particles of the second component and the cement (including comparable hydraulic binders such as slags, cement/slag mixes. etc.), they give rise to a grain-size distribution that controls the properties of the slurry. The particulate materials of the first component can be organic or inorganic and are selected for their low densities.

The low density is obtained by combining lightweight particles and cement. Nevertheless, Theological and mechanical properties will only be satisfactory if the size of the particles and the volume distribution thereof is selected in such a manner as to maximize the compactness of the solid mixture.

For a solid mixture having components falling in two distinct particle size bands, this maximum compactness is generally obtained for a volume ratio of first to second component lying in the range 70:30 to 85:15, and preferably in the range 75:25 to 80:20.

The first component preferably contains particles selected to be of a size that is in the order of 100 times the size of the particles of the second component, i.e. in general, particles that are greater than 100 μm in size. These values can vary, in particular as a function of the greater or lesser dispersion in the grain-size distribution of the particles. Particles having a mean size greater than 20 microns can also be used, either alone or in combination with the larger particles. Particles greater than 400 microns are generally not used because of the narrow size of the annular gaps to be cemented.

Mixtures having components that provide three or more distinct particle size bands are preferred since they make it possible to obtain greater compactness if the mean sizes of the various components are significantly different. For example, it is possible to use a mixture of lightweight particles having a mean size of 150 microns (coarse), lightweight particles having a mean size of 30 microns (and, optionally cement) (medium), and silica, and/or micro-cement (fine), e.g at a volume ratio close to 55:35:10. Such a mixture preferably comprises 50% to 60% (by volume) of the coarse lightweight particles of mean diameter lying in the range 100 μm to 400 μm, 30% to 45% of the medium lightweight particles of mean diameter lying in the range 20 μm to 40 μm, and 5% to 20% of fine particles.

Depending on the application, the medium size fraction size can include Portland cement, in particular class G Portland cement. It is possible to achieve the low density slurries of the present invention using only conventional cement, provided that the fine particle size band is present, preferably comprising silica. Other cements, such as class A, C and H, and non-API cements can also be used.

The term “micro-cement” is used in the invention to designate any hydraulic binder (cement, activated slags, cement/slag mixes) made up of particles of mean size of less than 5 μm and including no significant number of, particles of size greater than 10 μm. These typically have a specific surface area per unit weight as determined by the air permeability test that is generally about 0.8 m²/g.

The micro-cement can essentially be constituted by Portland cement, in particular a class G Portland cement typically comprising about 65% lime, 25% silica, 4% alumina, 4% iron oxides, and less than 1% manganese oxide, or equally well by a mixture of Portland micro-cement with microslag, i.e. a mixture making use essentially of compositions made from clinker comprising 45% lime, 30% silica, 10% alumina, 1% iron oxides and 5% to 6% manganese oxide (only the principal oxides are mentioned here; and these concentrations can naturally vary slightly as a function of the supplier). For very low temperature applications (<30° C.), Portland micro-cement is preferable over a mixture of micro-cement and slag because of its reactivity. If setting at right angles is required, plaster (gypsum) can be used for all or some of the middle-sized particles.

The cement content of the slurry can be maintained at a relatively low level (e.g. less than 30% by volume, preferably less than 20% by volume and in certain circumstances 15% by volume or less) while maintaining good physical properties of the set cement, particularly its compressive strength. The ability to provide such low densities with high solids content and low cement content while giving such properties is particularly surprising.

The lightweight particles typically have density of less than 2000 kg/m³, and generally less than 800 kg/m³. By way of example, it is possible to use hollow microspheres, in particular of silico-aluminate, known as cenospheres, a residue that is obtained from burning coal and having a mean diameter of about 150 μm. It is also possible to use synthetic materials such as hollow glass beads, and more particularly preferred are beads of sodium-calcium-borosilicate glass presenting high compressive strength or indeed microspheres of a ceramic, e.g. of the silica-alumina type. These lightweight particles can also be particles of a plastics material such as beads of polypropylene.

In general, the density of the slurry is adjusted essentially as a function of which materials are chosen to make up the two solid components, but it is also possible to vary the ratio of water to solid.

Naturally, the slurry can also include one or more additives of types such as: dispersants; antifreeze; water retainers; cement setting accelerators or retarders; and/or foam stabilizers, which additives are usually added to the liquid phase, or where appropriate incorporated in the solid phase.

Formulations made in accordance with the invention have mechanical properties that are significantly better than those of foamed cements having the same density. Compression strengths are very high and porosities very low. As a result, permeabilities are smaller by several orders of magnitude than those of same-density foamed cements, thereby conferring remarkable properties of hardness on such systems.

The method of the invention considerably simplifies the cementing operation, since it avoids any need for logistics of the kind required for foaming.

Slurries prepared in accordance with the invention also have the advantage of enabling all of the characteristics of the slurry (rheology, setting time, compressive strength, . . . ) to be determined in advance for the slurry as placed in the well, unlike foamed slurries where certain parameters can be measured on the slurry only prior to the introduction of gas (setting time).

The following examples illustrate the invention without limiting its scope.

### EXAMPLE 1

Low-density and low-porosity slurries can be obtained from mixtures of particles of two or three (or even more) different sizes, so long as the packing volume fraction (PVF) is optimized.

The properties of three slurries prepared in accordance with the invention are described and compared with those of a conventional low-density extended slurry and of a foamed system:

Slurry A: A mixture of powders was prepared. It comprised 55% by volume of hollow spheres taken from cenospheres having an average size of 150 microns (specific gravity 0.75); 35% by volume of glass microspheres having an average size of 30 microns; and 10% by volume of a mixture of Portland micro-cement and slag having a mean size of about 3 microns.

The microspheres used are sold by 3M under the name Scotchlite S60/10,000; such microspheres have a density of 600 kg/m³ and a grain-size distribution such that 10% of the particles (by volume) have a size of less than 15 μm, 50% less than 30 μm, and 90% less than 70 μm; these particles were selected in particular because of their high compressive strength (90% of the particles withstand isostatic compression of 68.9 MPa or 10,000 psi).

Water and the following additives were mixed with this powder so as to ensure that the volume percentage of liquid in the slurry was 42%: water retainer based on 2-acrylamido 2-methylpropane sulfonic acid (AMPS) at 0.2% (percent by weight of powder, i.e. all of the solid particles taken together (micro-cement, microspheres and cenospheres for this slurry A)); an antifoaming agent at 0.03 gallons per sack of powder; and a super-plasticizer based on polynaphthalene sulfonate at 0.07 gallons per sack of powder. It should be observed that a sack of powder is defined by analogy with sacks of cement, as being a sack containing 45.359 kg of mixture, in other words 1 gps=0.03834 liters (l) of additive per kg of mixture.

Slurry B: A mixture of powders was prepared. It comprised 78% by volume of hollow spheres obtained from cenospheres having a mean size of 150 microns and a density of 630 kg/m³, and 22% by volume of a mixture of Portland micro-cement and slag having a mean size of about 3 microns.

Water and the following additives were mixed with the powder so that the volume percentage of liquid in the slurry was 42%: water retainer based on AMPS polymer at 0.2% by weight of powder; antifoaming agent at 0.03 gallons per bag of powder; and a super-plasticizer based on polynaphthalene sulfonate at 0.1 gallons per bag of powder.

Slurry C: A mixture of powders was prepared. It comprised 78% by volume of Scotchlite glass microspheres having a mean size of 30 microns, and 22% by volume of a mixture of Portland micro-cement and slag having a mean size of about 3 microns.

Water and the following additives were mixed with said powder so that the volume percentage of liquid in the slurry was 45%: water retainer based on AMPS polymer at 0.2% by weight of powder; an antifoaming agent at 0.03 gallons per sack of powder; and a super-plasticizer based on polynaphthalene sulfonate at 0.145 gallons per sack of powder.

Slurry D: A mixture of powders was prepared. It comprised 78.4% by volume of hollow spheres derived from cenospheres having a mean size of 150 microns (density 720 kg/m³) and 21.6% by volume of class G Portland cement.

Water and the following additive were mixed with said powder so that the volume percentage of liquid in the slurry was 57%: an antifoaming agent at 0.03 gallons per sack of powder.

Slurry E: A conventional slurry of density 1900 kg/m³ was prepared based on a class G Portland cement.

The slurry was foamed with a quantity of foam of 50% so as to obtain a slurry whose final density was 950 kg/m³.

| Slurry | A | B | C | D | E |
|---|---|---|---|---|---|
| Density | 924 (7.7) | 1068 (8.9) | 1056 (8.8) | 1130 (9.4) | 950 (7.9) |
| Porosity | 42% | 42% | 45% | 57% | 78%* |
| PV | 87 | 68 | 65 | | |
| Ty | 3.7 (7.7) | 8.6 (18) | 3.4 (7.2) | | |
| CS | 11.7 (1700) | 19.3 (2800) | 14.5 (2100) | 2.48 (360) | 4.62 (670) |

*In this case, porosity was calculated as volume of gas + water over total volume of the slurry.

The densities are expressed in kg/m³ (and in pounds per gallon in parentheses). Rheology is expressed by a flow threshold Ty in Pascals (and in pounds per 100 square feet in parentheses), and by plastic viscosity in mPa.s or centipoise, using the Bingham fluid model. These parameters were determined at ambient temperature. CS means compressive strength after 24 hours for cement set at 60° C. (140° F.) at a pressure of 6.9 MPa (1000 psi), and it is expressed in Mpa (and in pounds per square foot in parentheses).

It can be seen that for the slurries prepared in accordance with the invention, compressive strength is particularly high for densities that are so low and that these slurries present excellent rheology in spite of their low porosity. Where the porosity is greater than 57% (Slurry D) the compressive strength becomes low.

### EXAMPLE 2

For slurries having a density greater than 8 pounds per gallon (ppg) (1000 kg/m³), a portion of the medium sized particles can comprise class G cement.

Slurry A: A mixture of powders was prepared. It comprised 55% by volume hollow spheres derived from cenospheres having a mean size of 150 microns, 35% by volume of Scotchlite glass microspheres having a mean size of 30 microns, and 10% by volume of a mixture of Portland micro-cement and slag having a mean size of about 3 microns.

Water and the following additives were mixed with the powder so that the volume percentage of the liquid in the slurry was 42%: water retainer based on AMPS polymer at 0.2% by weight of powder; an antifoaming agent at 0.03 gallons per sack of powder; and a super-plasticizer based on polynaphthalene sulfonate at 0.07 gallons per sack of powder.

Slurry B: A mixture of powders was prepared. It comprised 55% by volume of hollow spheres derived from cenospheres having a mean size of 150 microns, 25% by volume of Scotchlite glass microspheres having a mean size of 30 microns, 10% by volume of a class G Portland cement, and 10% by volume of a mixture of Portland micro-cement and slag having a mean size of about 3 microns.

Water and the following additives were mixed with the powder so as obtain a volume percentage of liquid in the slurry of 42%: water retainer based on AMPS polymer at 0.2% by weight of powder; an antifoaming agent at 0.03 gallons per sack of powder; and a super-plasticizer based on polynaphthalene sulfonate at 0.01 gallons per sack of powder.

Slurry C: A mixture of powders was prepared. It comprised 55% by volume of hollow spheres derived from cenospheres having a mean size of 150 microns, 20% by volume of Scotchlite glass microspheres having a mean size of 30 microns, 15% by volume of a class G Portland cement, and 10% by volume of a mixture of Portland micro-cement and slag having a mean size of about 3 microns.

Water and the following additives were mixed with the powder so that the volume percentage of liquid in the slurry was 42%: water retainer based on AMPS polymer at 0.2% by weight of powder; an antifoaming agent at 0.03 gallons per sack of powder; and a super-plasticizer based on polynaphthalene sulfonate at 0.01 gallons per sack of powder.

Slurry D: A mixture of powders was prepared. It comprised 55% by volume of hollow spheres derived from cenospheres having a mean size of 150 microns, 15% by volume of Scotchlite glass microspheres having a mean size of 30 microns, 20% by volume of a class G Portland cement, and 10% by volume of a mixture of Portland micro-cement and slag having a mean size of about 3 microns.

Water and the following additives were mixed with the powder so as to obtain a volume percentage of liquid in the slurry of 42%: water retainer based on AMPS polymer at 0.2% by weight of powder; an antifoaming agent at 0.03 gallons per sack of powder; and a super-plasticizer based on polynaphthalene sulfonate at 0.01 gallons per sack of powder.

Densities are expressed in kg/m³ (and in pounds per gallon in parentheses). Rheology is expressed by the flow threshold Ty in Pascals (and in pounds per 100 square feet in parentheses), and by plastic viscosity PV in mPa.s or centipoise, using the Bingham fluid model. These parameters were determined at ambient temperature. CS stands for compression strength after 24 hours and after 48 hours for cement setting at 60° C. at a pressure of 6.9 MPa (1000 psi), expressed in MPa (and in pounds per square foot in parentheses).

| Slurry | A | B | C | D |
|---|---|---|---|---|
| Density | 924 (7.7) | 1068 (8.9) | 1140 (9.5) | 1218 (10.15) |
| Porosity | 42% | 42% | 42% | 42% |
| PV | 87 | 90 | 100 | 109 |
| Ty | 7.7 | 8.8 | 9.0 | 11.2 |
| CS (24 h) | 7.58 (1100) | 18.3 (2650) | 19.7 (2850) | 20.7 (3000) |
| CS (48 h) | 9.0 (1300) | 19.0 (2750) | 29.7 (4300) | 28.3 (4100) |

Adding Portland cement as a portion of the “medium-sized” particles makes it possible to cover the entire range of densities from 1000 kg/m³ to 1300 kg/m³ and significantly improves compressive strength. This addition does not disturb the good Theological properties in any way.

### EXAMPLE 3

For slurries having a density greater than 1000 kg/m³, increasing the proportion of the fine particle phase can give rise to improved performance.

Slurry A: A mixture of powders was prepared. It comprised 55% by volume hollow spheres derived from cenospheres having a mean size of 150 microns, 30% by volume of Scotchlite glass microspheres having a mean size of 30 microns, and 15% by volume of a mixture of Portland micro-cement and slag having a mean size of about 3 microns.

Water and the following additives were mixed with the powder so that the volume percentage of the liquid in the slurry was 42%: water retainer based on AMPS polymer at 0.2% by weight of powder; an antifoarning agent at 0.03 gallons per sack of powder; and a super-plasticizer based on polynaphthalene sulfonate at 0.07 gallons per sack of powder.

Slurry B: A mixture of powders was prepared. It comprised 55% by volume hollow spheres derived from cenospheres having a mean size of 150 microns, 25% by volume of Scotchlite glass microspheres having a mean size of 30 microns, and 20% by volume of a mixture of Portland micro-cement and slag having a mean size of about 3 microns.

Water and the following additives were mixed with the powder so that the volume percentage of the liquid in the slurry was 42%: water retainer based on AMPS polymer at 0.2% by weight of powder; an antifoaming agent at 0.03 gallons per sack of powder; and a super-plasticizer based on polynaphthalene sulfonate at 0.07 gallons per sack of powder.

| Slurry | A | B |
|---|---|---|
| Density | 990 (8.25) | 1056 (8.8) |
| Porosity | 42% | 42% |
| CS (24 h) | 11.2 (1630) | 21.4 (3100) |
| CS (48 h) | 11.7 (1700) | 22.1 (3200) |

Densities are expressed in kg/m³ (and in pounds per gallon in parentheses). CS means compressive strength after 24 hours and 48 hours for cement set at 60° C. under a pressure of 6.9 MPa (1000 psi), expressed in MPa (and in pounds per square foot in parentheses).

Increasing the content of micro-cement and slag mixture gives rise to exceptional compression strength performance at 9 ppg.

### EXAMPLE 4

Depending on the desired mechanical properties (flexibility, ability to withstand high pressures), various lightweight particles can be used so long as the PVF is optimized.

Slurry A: A mixture of powders was prepared. It comprised 55% by volume hollow spheres derived from cenospheres having a mean size of 150 microns, 30% by volume of hollow spheres derived from cenospheres having a mean size of 45 microns, and 15% by volume of a mixture of Portland micro-cement and slag having a mean size of about 3 microns.

Water and the following additives were mixed with the powder so that the volume percentage of the liquid in the slurry was 42%: water retainer based on AMPS polymer at 0.2% by weight of powder; an antifoaming agent at 0.03 gallons per sack of powder; and a super-plasticizer based on polynaphthalene sulfonate at 0.07 gallons per sack of powder.

Slurry B: A mixture of powders was prepared. It comprised 55% by volume of particles of polypropylene having a means size of 300 microns, 30% by volume of Scotchlite glass microspheres having a mean size of 30 microns, and 15% by volume of a mixture of Portland micro-cement and slag having a mean size of about 3 microns.

Water and the following additives were mixed with the powder so that the volume percentage of the liquid in the slurry was 42%: a retarder based on purified lignosulfonates at 0.22% by weight of powder; a water retainer based on AMPS polymer at 0.2% by weight of powder; and a super-plasticizer based on polynaphthalene sulfonate at 0.05 gallons per bag of powder.

| Slurry | A | B |
|---|---|---|
| Density | 990 (8.25) | 1068 (8.9) |
| Porosity | 42% | 42% |
| PV | 93 | 116 |
| Ty | 20 | 9.3 |
| CS (24 h) | 18.3 (2640) | 10.3 (1500)* |
| CS (48 h) | 18.7 (2700) | 22.1 (3200)* |
| Densities are expressed in kg/m³ (and in pounds per gallon in parentheses). Rheology is expressed by the flow threshold Ty in Pascals (and in pounds per 100 square feet in parentheses), and by plastic viscosity PV in mPa · s or centipoises, using the Bingham fluid model. These parameters were determined at ambient temperature. CS means comprehensive strength at 24 hours and at 48 hours from the | | |
| # cement setting at 60° C. under 6.9 MPa (1000 psi), expressed in MPa (and in pounds per square foot in parentheses). | | |

*Comprehensive strength at 24 hours for cement set at 104° C. (220° F.) under a pressure of 20.7 MPa (3000 psi), expressed in MPa and in psi in parentheses.

### EXAMPLE 5

For low temperature applications, the mixture of micro-cement and slag can be substituted by pure micro-cement, or plaster can be added to the medium-sized particles.

We have compared a formulation of the invention with a foamed plaster formulation.

Slurry A: A mixture of powders was prepared. It comprised 42.7% by volume of hollow spheres derived from cenospheres having a mean size of 150 microns, 20% by volume of hollow spheres derived from cenospheres having a mean size of 45 microns, 27.3% by volume of gypsum, and 10% by volume of a mixture of Portland micro-cement and slag having a mean size of about 3 microns.

Water and the following additives were mixed with the powder so that the volume percentage of liquid in the slurry was 42%: retarder based on purified lignosulfonates at 0.05 gallons per sack of powder; a water retainer of the example at 0.04 gallons per sack of powder; and an antifoaming agent at 0.03 gallons per sack of powder.

Slurry B (reference): This slurry corresponds to the prior art. A mixture of powders was prepared. It comprised 40% by volume of class G cement and 60% by volume of plaster. Water and additives were mixed with the powder so that the density of the slurry was 1900 kg/m³ (15.8 ppg).

To foam this slurry, entirely conventional wetting agents were added: D138 and F052.1 in a 1:1 ratio. The quantity added depends on foam quality. It was adjusted so as to obtain a slurry having a density of 1320 kg/m³ (11 pounds per gallon).

| Densities | | 1320(11) | 1218(10.15) |
|---|---|---|---|
| Slurry A | Q | | 0 |
| (of the | PV | | 112 |
| invention) | Ty | | 6.7 |
| | CS (at 12 hours for cement set at | | 2.41(350) |
| | 4° C. under 6.9 MPa) | | |
| | CS (at 24 hours for cement set at | | 14.8(2150) |
| | 25° C. under 6.9 MPa) | | |
| Slurry B | Q | 30% | |
| (reference) | CS (at 24 hours for cement set at | 2.96(430) | |
| | 18° C. under atmospheric pressure) | | |
| | CS (at 48 hours for cement set at | 4.55(660) | |
| | 18° C. under atmospheric pressure) | | |

Densities are expressed in kg/m³ (and in pounds per gallon in parentheses). Rheology is expressed by the flow threshold Ty in Pascals (and in pounds per 100 square feet in parentheses), and by plastic viscosity PV in mPa.s or centipoises, using the Bingham fluid model. These parameters were determined at ambient temperature. CS stands for compressive strength under conditions stated in the table, expressed in MPa (and in pounds per square foot in parentheses). Q is the foam quality, i.e. the ratio of gas volume to the total volume of the foamed slurry.

### EXAMPLE 6

Low density slurries of the invention can be achieved with all of the cement being found in the medium particle size band. Compositions and properties of slurries (A & B) of this type are shown in the table below:

| | Slurry A | Slurry B |
|---|---|---|
| Density ppg | 9.90 (1186 kg/m³) | 8.66 (1039 kg/m³) |
| Porosity | 42% | 40% |
| Cement (Class G, SG 3.2, | 14% BVOB | 14% BVOB |
| 20-50 micron) | 33.81% BWOB | 42.03% BWOB |
| Silica Fume (0.5 micron) | 16% BVOB | 16% BVOB |
| | 26.57% BWOB | 33.02% BWOB |
| Cenospheres (SG 0.75, | 70% BVOB | |
| 130 micron) | 39.62% BWOB | |
| Glass Micro-bubbles (SG | | 70% BVOB |
| 0.38, 40 micron) | | 24.95% BWOB |
| Dispersant | 0.150 gps | 0.150 gps |
| Antifoam | 0.030 gps | 0.030 gps |
| Water | 6.369 gps | 7.260 gps |
| Compressive Strength* | | |
| Test 1 | 1840 psi | 1820 psi |
| Test 2 | 1820 psi | 1750 psi |

*measured after curing for 10 days at room temperature and ambient pressure.

1 A well cementing slurry, comprising a solid fraction and a liquid fraction and having a density of less than about 1500 kg/m³, wherein the solid fraction comprises a mixture of solid particulate materials including cement, the mixture comprising:
60% to 90% by volume of the solid fraction of a first component comprising particles having a mean size lying in the range 20 microns to 400 microns and a density of less than 2000 kg/m³; and
10% to 30% by volume of the solid fraction of a second component having a mean particle diameter of less than 5 microns.

2 A slurry as claimed in claim 1, wherein the solid fraction comprises
70% to 85% by volume of the first component; and
15 to 30% by volume of the second component.

3 A slurry as claimed in claim 1, wherein the first component comprises up to 20% by volume of the solid fraction of cement.

4 A slurry as claimed in claim 1, wherein the first component comprises a coarse particle size fraction with a mean particle size of 100-400 microns.

5 A slurry as claimed in claim 1, wherein the first component comprises a medium particle size fraction with a mean particle size of 20-50 microns.

6 A slurry as claimed in claim 1, wherein the first component comprises:
a coarse particle size fraction with a mean particle size of 100-400 microns; and
a medium particle size fraction with a mean particle size of 20-50 microns.

7 A slurry as claimed in claim 6, wherein the medium particle size fraction comprises cement.

8 A slurry as claimed in claim 7, wherein the second component comprises silica.

9 A slurry as claimed in claim 4, wherein the particles of the coarse particle size fraction are approximately 100 times the means particle size of the second component.

10 A slurry as claimed in claim 9, wherein the particles of the coarse particle size fraction have a mean particle size of greater than 100 microns.

11 A cementing slurry as claimed in claim 1, wherein the cement comprises a mixture of Portland cement and microslag.

12 A slurry as claimed in claim 1, wherein the first component comprises particle having a density of less than 800 kg/m³.

13 A slurry as claimed in claim 1, wherein the first component comprises at least one material selected from the group consisting of hollow microspheres, silico-aluminate cenospheres, hollow glass beads, sodium-calcium-borosilicate glass beads, ceramic microspheres, silica-alumina micropsheres, plastics materials and polypropylene beads.

14 A slurry as claimed in claim 1, further comprising at least one additive selected from the group consisting of dispersants, antifreezes, water retainers, cement setting accelerators, cement setting retarders and foam stabilizers.

15 A slurry as claimed in claim 1, having a density in the range 900 kg/m³ to 1300 kg/m³.

16 A slurry as claimed in claim 15, having a density in the range 900 kg/m³ to 1100 kg/m³.

17 A slurry as claimed in claim 1, having a porosity, measured at the volume of liquid fraction over the total slurry volume, of less than 55%.

18 A slurry as claimed in claim 17, wherein the porosity is from about 38% to about 50%.

19 A slurry as claimed in claim 17, wherein the porosity is less than 45%.

20 A slurry as claimed in claim 1, wherein the cement comprises 30% or les by volume of the solid phase.
